(19) United States
(12) Patent Application Publication
(10) Pub. No.: US 2026/0278173 A1
(43) Pub. Date: Sep. 17, 2026

(54) METHODS FOR VERIFICATION OF A PART OF A CONTENT AND RELATED ELECTRONIC DEVICE

(71) Applicant: MAERSK A/S, Copenhagen K (DK)

(72) Inventor: Fabio Krauss Stabel DE CARVALHO, Copenhagen K (DK)

(21) Appl. No.: 19/168,211

(22) PCT Filed: Feb. 28, 2024
(86) PCT No.: PCT/DK2024/050038

§ 371 Date: Sep. 23, 2025

(30) Foreign Application Priority Data
Mar. 24, 2023 (DK) PA202370146

(51) Int. Cl. G06F 21/64; H04L 9/00; H04L 9/32

(52) U.S. Cl. CPC G06F 21/64; H04L 9/3236; H04L 9/50

(57) ABSTRACT

Disclosed is a method, performed by an electronic device, for enabling verification of a second part of a content. The method comprises obtaining an authentication tree comprising a root and authentication tree data associated with the content data, wherein the authentication tree data comprises path hash values associated with a first path of the authentication tree between the second part and the root. The method comprises providing the second part, and verification data associated with the second part, wherein the verification data comprises the path hash values. 2B to be published

The present disclosure pertains to the field of security and control of content, such as electronic content. The present disclosure relates to methods for verification of a part of a content and related electronic devices.

### BACKGROUND

Content, such as electronic documents, may contain various parts. Some parts of the content may include comprise sensitive information. One may want to share or send only a part of the content to a recipient securely. For example, an external consultant may be provided with a clause of a contract to be evaluated but access to other parts of the contract is to be prevented.

### SUMMARY

In some examples, a part of a content may need to be analysed without having to disclose the full content to the analyst.

There is a need for sharing a part of content without sharing the entire content while ensuring integrity of the shared part and ensuring that the part shared does indeed form part of the intended content.

Accordingly, there is a need for electronic devices and methods for verification of a part of a content, which mitigate, alleviate, or address the existing shortcomings and allows sharing a part of content without sharing the entire content while ensuring integrity of the shared part and ensuring that the part shared does indeed form part of the intended content.

Disclosed is a method, performed by a first electronic device, for enabling verification of a second part of a content. The method comprises obtaining an authentication tree comprising a root and authentication tree data associated with the content data, wherein the authentication tree data comprises path hash values associated with a first path of the authentication tree between the second part and the root. The method comprises providing the second part, and verification data associated with the second part, wherein the verification data comprises the path hash values.

Further, a first electronic device is disclosed. The first electronic device comprises memory circuitry, processor circuitry, and an interface. The first electronic device is configured to perform any of the methods disclosed herein.

Disclosed is a computer readable storage medium storing one or more programs, the one or more programs comprising instructions, which when executed by a first electronic device with a display and a touch-sensitive surface cause the first electronic device to perform any of the methods disclosed herein.

It is an advantage of the present disclosure that the disclosed first electronic device and method allow verification of a part of a content at a recipient side. For example, the part shared with a receiving party can be verified to belong to the content without sharing the entire content. Therefore, the entire content does not need to be shared for verification of the authenticity of the text shared with the receiving party. Also the disclosed first electronic device and method enable the recipient to validate the part of the content based on checking the integrity of the part received. This allows for increased security of the access to the content and ensures confidentiality of other parts of the content which may include sensitive information while protecting integrity of the part shared and ensuring that the part shared does indeed form part of the content.

Disclosed is a method, performed by a second electronic device, for verifying a validity of a part of a content. The method comprises obtaining the second part and verification data associated with the second part. The verification data comprises path hash values of an authentication tree associated with the content data. The authentication tree includes a root and is characterized by a one-way function. The path hash values are for a path between the second part and the root. The method comprises determining one or more path hash values of the one or more paths of the authentication tree between the second part and the root of the authentication tree. The method comprises verifying the validity of the second part based on the one or more determined path hash values and the verification data.

Further, a second electronic device is disclosed. The second electronic device comprises memory circuitry, processor circuitry, and an interface. The second electronic device is configured to perform any of the methods disclosed herein.

Disclosed is a computer readable storage medium storing one or more programs, the one or more programs comprising instructions, which when executed by a second electronic device cause the second electronic device to perform any of the methods disclosed herein.

It is an advantage of the present disclosure that the disclosed second electronic device and method benefit from verifying of a part of a content. For example, the part shared with the second electronic device can be verified to belong to the content without the second electronic device having access to other parts of the content. Also the disclosed second electronic device and method benefit from validating the part of the content based on checking the integrity of the part received. This may provide the second electronic device as the receiving party with transparency regarding the part shared.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating schematically an example system where the disclosed technique is carried out according to this disclosure,

FIGS. 2A-B are illustrations of example authentication trees according to this disclosure;

FIG. 3 is a flow-chart illustrating an example method, performed by a first electronic device, for enabling verification of a second part of a content according to this disclosure;

FIG. 4 is a flow-chart illustrating an example method, performed by a second electronic device, for verifying a validity of a part of a content according to this disclosure;

FIG. 5 is a block diagram illustrating an example first electronic device according to this disclosure; and

FIG. 6 is a block diagram illustrating an example second electronic device according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

A content may be seen as information forming a set. In some examples, the content is an electronic document (such as a legal document, such as contract) and/or a file. In some examples, the content is characterized by content data. The content may have a given structure, for example, contracts have distinct parts: clauses. The part may be in form of a JavaScript Object Notation (JSON) object and/or a block of text. The content can be generated modularly by a system. For example, a digital contract can be generated modularly by a system, e.g., based on a database of clauses used to compose an object that has references to clauses.

A part of the content, e.g., a first part, a second part, a third part, etc., of the content, for example comprises content data. A part of the content may be seen as a section (e.g., a segment) of the content. For example, when the content is a contract, the part (e.g., the first part and/or the second part) may be a clause of a contract.

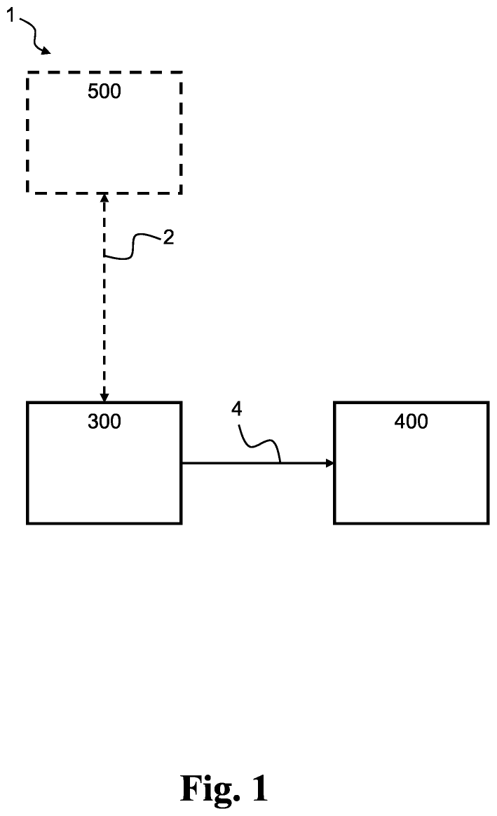

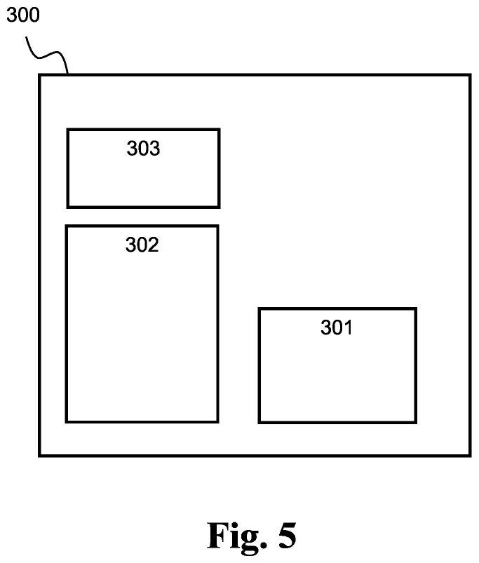

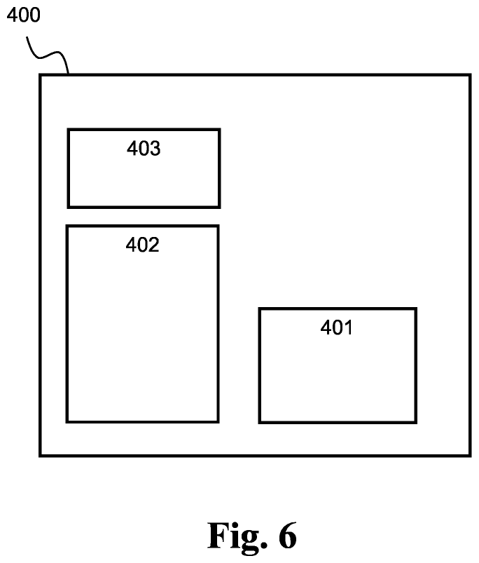

FIG. 1 shows schematically an example system 1 including an example first electronic device (such as electronic device 300 of FIG. 5) and an example second electronic device 400 (such as electronic device 400 of FIG. 6) according to this disclosure. The first electronic device 300 may for example be seen as a sender of a part of a content, where the part to be sent is to be validated at the receiving side, e.g. based on checking the integrity of the part received and/or on demonstrating that the part does indeed belong to the content, without providing access to the entire content. In other words, the first electronic device 300 can be seen as a sender of the part of the content to be shared with a receiving party, such as the second electronic device 400.

The second electronic device 400 may be seen as a receiving device configure to verify and/or validate a part of the content received from the first electronic device 300. The second electronic device 400 is for example communicatively coupled via link 4 with the first electronic device 300. In other words, the second electronic device 400 may be configured to provide (e.g., transmit) data and/or obtain (e.g., receive) data from the first electronic device 300. For example, the second electronic device 400 may be configured to obtain (e.g. receive) from the first electronic device 300 a second part and/or verification data associated with the second part. For example, the first electronic device 300 may be configured to provide (e.g. send) a second part and/or verification data associated with the second part to the second electronic device 400. In some examples, the second electronic device 400 can validate the second part of the content using the verification data received. For example, the verification data allows the second electronic device 400 to validate that the second part does indeed belong to the content and that the second part has not been modified by an unauthorized party.

In some examples, the verification data comprises path hash values of an authentication tree associated with the content data. In some examples, the first electronic device 300 stores the authentication tree, e.g. in memory circuitry. In some examples, the first electronic device 300 can retrieve the authentication tree from a server device, such as server device 500.

FIG. 1 shows a server device 500. The server device 500 is communicatively coupled via link 2 with the first electronic device 300. In other words, the server device 500 may be configured to provide (e.g., transmit) data to and/or obtain (e.g., receive) data from the first electronic device 300. For example, the server device 500 may be configured to provide the authentication tree to the first electronic device 300, e.g. based on a request from the first electronic device 300. In some examples, the server device 500 may be configured to receive (e.g. from the first electronic device 300) a request for provision (e.g., transmission) of an authentication tree.

For example, first electronic device 300 may be configured to provide (e.g., transmit) data to and/or obtain (e.g., receive) data from the server device 500. For example, the first electronic device 300 may be configured to obtain the authentication tree from the server device 500. In some examples, the first electronic device 300 may be configured to provide (e.g., to the server device 500) a request for provision (e.g., transmission) of an authentication tree.

In some examples, the first electronic device 300 generates the authentication tree and optionally stores the authentication tree in the server device 500.

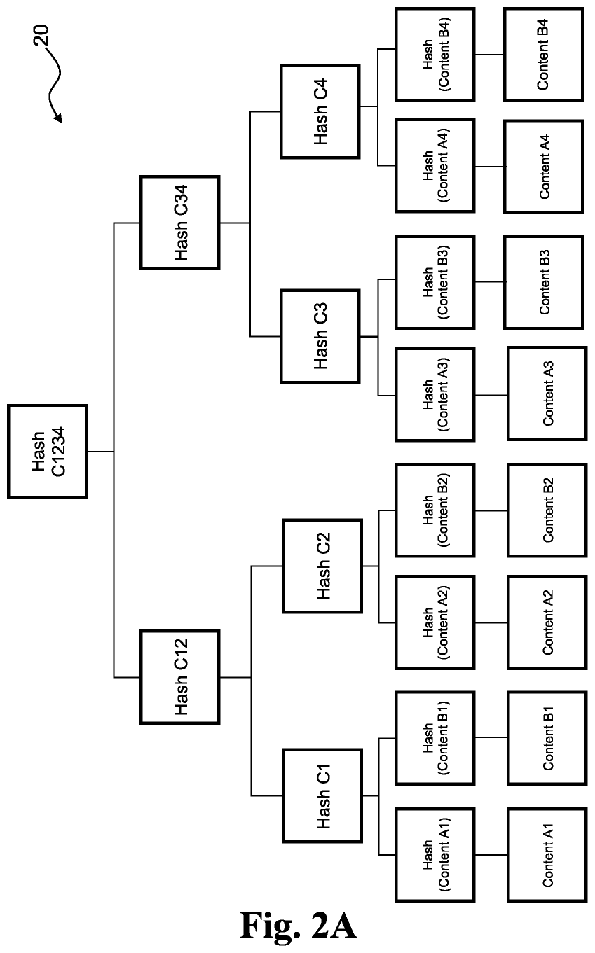

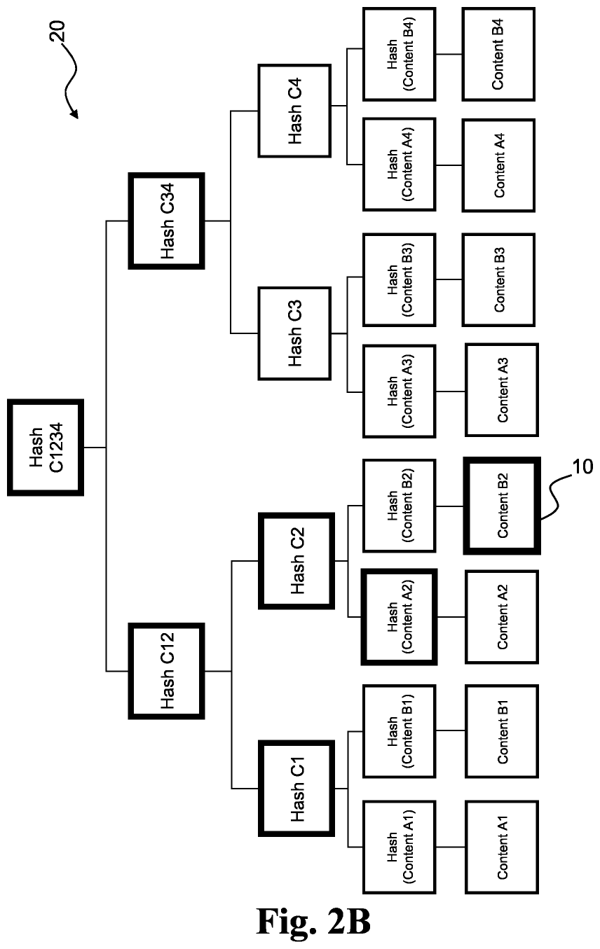

FIGS. 2A-B are illustrations of example authentication trees according to this disclosure.

FIG. 2A shows an authentication tree 20 associated with content data.

The content data is for example segmented in one or more pairs: A1, B1, A2, B2, A3, B3, and A4, B4. The pairs can be generated using a delimiter. FIG. 2A shows that a pair includes a first part and a second part. The authentication tree 20 comprises 8 parts of the content data. In some examples, the content data comprises one or more of Content A1-4and Content B1-4. Content A1-4 and Content B1-4 may be seen as parts (e.g., clauses of a contract). In other words, the content data comprises one or more parts. Stated differently, for example, when the content is a contract having clauses, the pairs may correspond to pairs of clauses. In some examples, the content is segmented in pairs of adjacent parts, such as in pairs of adjacent clauses (e.g. in the original order). In other words, adjacent parts are not overlapping.

For example, Content A1 may be seen as a first part. Content B1 may be seen as a second part. Content A2 may be seen as a third part. Content B2 may be seen as a fourth part. Content A3 may be seen as a fifth part. Content B3 may be seen as a sixth part. Content A4 may be seen as a seventh part. Content B4 may be seen as an eighth part.

In some examples, two parts may be seen as a pair. A pair may comprise two parts. Each pair is for example generated, based on a delimiter. A pair may be seen as comprising a first part and a second part. For example, the Authentication tree 20 comprises 4 pairs of parts.

For example, Content A1 and Content B1 comprise a first pair. For example, Content A2 and Content B2 comprise a second pair. For example, Content A3 and Content B3 comprise a third pair. For example, Content A4 and Content B4 comprise a fourth pair. A pair may for example comprise two clauses of a contract.

In other words, the first pair may comprise the first part and the second part. The second pair may comprise the third part and the fourth part. The third pair may comprise the fifth part and the sixth part. The fourth pair may comprise the seventh part and the eighth part.

In some examples, each of the one or more parts are associated with a hash value, such as a path hash value. The hash value associated with the part is for example generated by applying a one-way function (e.g., a hash function) to the part.

The authentication tree 20 may be seen as a data structure used for integrity protection and for showing that a part of the content does belong to the content that the part claims to originate from, without disclosing any other part of the content. In some examples, the authentication tree is a hash tree, such as a Merkle authentication tree and/or a Verkle authentication tree and/or a modified version of a Merkle authentication tree. In other words, for example the authentication tree can be used to provide verifiable authenticity of a part of a content shared, by using a tree structure in conjunction with a one-way function, and a root value. The authentication tree comprises a root and authentication tree data. In some examples, the one-way function is a hash function.

In some examples, the authentication tree comprises leaf nodes which are hashes of data blocks in a content, such as a file, and/or an electronic document. In some examples, nodes further up in the authentication tree are the hashes of their respective children. In other words, a node is a result of a one-way function applied to its child or children. In other words, the authentication tree may be seen as a hash tree in which each node's hash value (so called path hash value) is computed from the hash value of its child node(s). The path hash value can be seen as a hash value associated with a node in the path between a part of the content and the root of the authentication tree. For example, the path between Content A1 and the root comprises one or more of: Hash (Content A1), Hash C1, and Hash C12. The Hash C1234 of authentication tree 20 is for example a root (e.g., a root hash value) of the authentication tree. The authentication tree 20 for example comprises path hash values, such as Hash (content A1), Hash C1, Hash C12 etc.

For example, the path hash value is determined by applying a one-way function (e.g., a hash function) to a child leaf. The path hash values are, for example, associated with a path of the authentication tree 20. The authentication tree 20, for example, comprises four paths. Each path is, for example, associated with a part of the content, such as a pair (e.g., a pair of parts of the content). The path hash value can be seen as a hash value associated with a path of the authentication tree towards the root.

The authentication tree 20 comprises a first primary path hash value associated with the first part. The first primary path hash value is shown in FIG. 2 as Hash(Content A1) for Content A1. The authentication tree 20 comprises a first secondary path hash value associated with the first part. The first secondary path hash value is shown in FIG. 2 as Hash(Content B1). The Authentication tree 20 comprises a first tertiary path hash value associated with a first path of the authentication tree between the root and at least one of the first part and the second part. The first tertiary path hash value is shown in FIG. 2 as Hash C1.

The first primary path hash value (e.g., Hash(Content A1)) for example is determined by applying the one-way function to the first part, e.g. Content A1. The first secondary path hash value (e.g., Hash(Content B1)) for example is determined by applying the one-way function to the second part, e.g. Content B1. The first tertiary path hash value (e.g. Hash C1) for example is determined by applying the one-way function to the first primary path hash value (e.g., Hash(Content A1)) and the first secondary path hash value (e.g., Hash(Content B1)). In other words, Hash C1 is determined by applying the one-way function to Hash(Content A1) and Hash(Content B1). This is iterated recursively for each leaf until the root hash value can be calculated.

The authentication tree 20 comprises a second primary path hash value associated with the third part, e.g. Content A2. The second primary path hash value is shown in FIG. 2 as Hash(Content A2). The authentication tree 20 comprises a second secondary path hash value associated with the fourth part. The second secondary path hash value is shown in FIG. 2 as Hash(Content B2). The Authentication tree 20 comprises a second tertiary path hash value associated with a second path of the authentication tree between the root and at least one of the third part and the fourth part (Content B2). The second tertiary path hash value is shown in FIG. 2 as Hash C2.

The second primary path hash value (e.g., Hash(Content A2)) for example is determined by applying the one-way function to the third part. Determining the second secondary path hash value (e.g., Hash(Content B2)) for example comprises applying the one-way function to the fourth part. The second tertiary path hash value for example is determined by applying the one-way function to the second primary path hash value and the second secondary path hash value. In other words, for example, Hash C2 is determined by applying the one-way function to Hash(Content A2) and Hash(Content B2).

The authentication tree 20 comprises a first quaternary path hash value, e.g. Hash C12.The first quaternary path hash value may be associated with the first path of the authentication tree between the root and at least one of the first part and the second part and with the second path of the authentication tree between the root and at least one of the third part and the fourth part. The first quaternary path hash value is shown in FIG. 2 as Hash C12. The first quaternary path hash value for example is determined by applying the one-way function to the first tertiary path hash value and the second tertiary path hash value. In other words, for example, Hash C12 is determined by applying the one-way function to Hash C1 and Hash C2.

The authentication tree 20 comprises a third primary path hash value associated with the fifth part. The third primary path hash value is shown in FIG. 2 as Hash(Content A3). The authentication tree 20 comprises a third secondary path hash value associated with the sixth part. The third secondary path hash value is shown in FIG. 2 as Hash(Content B3). The authentication tree 20 comprises a third tertiary path hash value associated with a third path of the authentication tree between the root and at least one of the fifth part (e.g. content A3) and the sixth part (e.g. content B3). The third tertiary path hash value is shown in FIG. 2 as Hash C3. Determining the third primary path hash value (e.g., Hash(Content A3)) for example comprises applying the one-way function to the fifth part. Determining the third secondary path hash value (e.g., Hash(Content B3)) for example comprises applying the one-way function to the sixth part. Determining the third tertiary path hash value for example comprises applying the one-way function to the third primary path hash value and the third secondary path hash value. In other words, determining Hash C3 may comprise applying the one-way function to Hash(Content A3) and Hash(Content B3).

The authentication tree 20 comprises a fourth primary path hash value associated with the seventh part. The fourth primary path hash value is shown in FIG. 2 as Hash(Content A4). The authentication tree 20 comprises a fourth secondary path hash value associated with the eighth part. The fourth secondary path hash value is shown in FIG. 2 as Hash(Content B4). The authentication tree 20 comprises a fourth tertiary path hash value associated with a fourth path of the authentication tree between the root and at least one of the seventh part and the eighth part. The fourth tertiary path hash value is shown in FIG. 2 as Hash C4. Determining the fourth primary path hash value (e.g., Hash(Content A4)) for example comprises applying the one-way function to the seventh part. Determining the fourth secondary path hash value (e.g., Hash(Content B4)) for example comprises applying the one-way function to the eighth part. Determining the fourth tertiary path hash value for example comprises applying the one-way function to the fourth primary path hash value and the fourth secondary path hash value. In other words, determining Hash C4 may comprise applying the one-way function to Hash(Content A4) and Hash(Content B4).

The authentication tree 20 comprises a second quaternary path hash value, Hash C34. The second quaternary path hash value may be associated with a third path of the authentication tree between the root and at least one of the fifth part and the sixth part. The second quaternary path hash value may be associated with a fourth path of the authentication tree between the root and at least one of the seventh part and the eighth part. The second quaternary path hash value is shown in FIG. 2 as Hash C34.

Determining the second quaternary path hash value for example comprises applying the one-way function to the third tertiary path hash value and the fourth tertiary path hash value. In other words, determining Hash C34 may comprise applying the one-way function to Hash C3 and Hash C4.

The root hash value (Hash C1234) is for example associated with the first path, the second path, the third path and the fourth path of the authentication tree between the root and content leaves.

FIG. 2B shows an authentication tree 20 used for verification of a part 10 (e.g., the part to be verified, e.g. content B2). The part 10 of the authentication tree 20 is Content B2. For example, the part 10 may be seen as a clause of a contract to be verified. The part 10 may for example be seen as the second part of the second pair.

The part 10 is for example a part of a document which is sent to or shared with a recipient. The recipient can use verification data to validate that part 10 has not been tampered with and does belong to the content that part 10 claims to be from.

The authentication tree 20 for example comprises verification data associated with the part 10. The verification data of the authentication tree 20 for example comprises path hash values. The verification data of authentication tree 20 for example comprises one or more path hash values associated with the second path including the part 10.

In some examples, the verification data associated with the part 10 comprises one or more of: the second primary path hash value, the first tertiary path hash value, the second tertiary path hash value, the first quaternary path hash value, the second quaternary path hash value and the root hash value. In other words, for the authentication tree 20, the verification data associated with Content B2 may comprise one or more of: Hash(Content A2), Hash C1, Hash C2, hash C12, Hash C34 and Hash C1234.

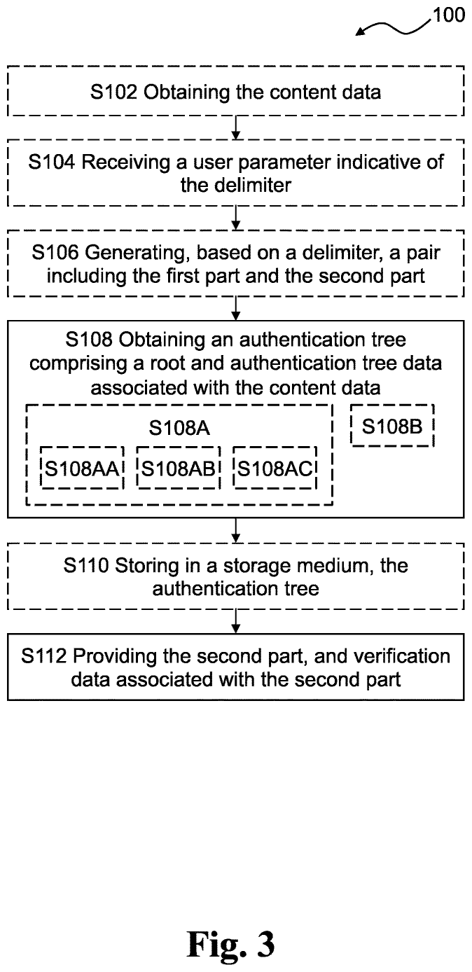

FIG. 3 shows a flow diagram of an example method, performed by a first electronic device, for enabling verification of a second part of a content according to the disclosure. The method 100 is performed by a first electronic device, such as the first electronic device disclosed herein, such as first electronic device 300 of FIG. 5.

The first electronic device is for example the sender (e.g., transmitter) of the second part (e.g., a part of content data, e.g., a part of raw content data) and/or verification data (e.g., path hash values). For example, the first electronic device is configured to send (e.g., to the second electronic device) the part of raw content data and the verification data for verification of the part of raw content data.

In one or more exemplary methods, the content comprises an electronic document. In some examples, the content is represented by content data (e.g., textual data for an electronic document). A part of the content may be seen as a part of the content data, such as a part of an electronic document, such as a part of a clause of a legal document.

The method 100 comprises obtaining S108 an authentication tree (e.g. receiving from a server device and/or generating the authentication tree). In some examples, the authentication tree comprises a root and authentication tree data associated with the content data. In some examples, the authentication tree data comprises path hash values associated with a first path of the authentication tree between the second part and the root. Authentication tree data can be seen as data characterizing the authentication tree, such as a root, a path hash value, segmented content data and/or a one-way function. In some examples, authentication tree data associated with the content data comprises path hash values along a path of the authentication tree. Path hash values are for example hash values associated with a path of an authentication tree (e.g., from a leaf to the root). The path hash values are for example based on the values of respective child nodes (which may be parts of content data of the authentication tree and/or hash values depending on their level in the tree). For example, authentication tree data associated with the content data comprises data (e.g. hash values) associated with one or more nodes of the tree, such as child nodes, parent nodes and/or one or more sibling nodes associated with the content, as illustrated in example of FIGS. 2A-B.

In some examples, the authentication tree data obtained may be a part of the authentication tree that is associated with the second part of the content data to be shared. In some examples, the authentication tree data associated with the second part for example comprises a first primary path hash value, a first secondary path hash value, a first tertiary path hash value and a root hash value for a content formed by Content A1 and Content B1 of FIG. 2A. In some examples, the authentication tree data associated with the second part for example comprises all the hash values shown in FIG. 2A for a content formed by Content A1-B1, Content A2-B2, Content A3-B3, Content A4-B4 of FIG. 2A. It may be appreciated that in some examples, not all hash values are necessary for sharing a part of the content and showing its validity to the recipient. In the example authentication tree shown in FIGS. 2A-B, the authentication tree data associated with the content data comprises one or more of: the first primary path hash value, the first secondary path hash value, the first tertiary path hash value, the second primary path hash value, the second secondary path hash value, the second tertiary path hash value, the first quaternary path hash value, the second quaternary path hash value, the third primary path hash value, the third secondary path hash value, the third tertiary path hash value, the fourth primary path hash value, the fourth secondary path hash value, the fourth tertiary path hash value and the root hash value.

A path of the authentication tree may be seen a path (e.g., a route) along the path hash values of the authentication tree from a node to the root. For example, the first path may be seen as a path from the first part (e.g., Content A1 of FIGS. 2A-B) to the root (e.g., Hash C1234 of FIG. 2A-B). For example, the path from a part (e.g., the first part) of the authentication tree to the root of the authentication tree may be a path including one or more (e.g., all) sibling nodes (e.g., adjacent nodes) on the path from the part to the root hash value.

The method 100 comprises providing S112 the second part, and verification data associated with the second part. For example, the second part (e.g., the raw second part) is provided in clear form. In some examples, the verification data comprises the path hash values. The verification data may be seen as a subset of the authentication tree that is necessary to check validity of the second part. For example, when a content contains only a first part and a second part, the verification data for the second part comprises a first primary path hash value associated with the first part, and a root hash value. For example, when the content is as illustrated in FIG. 2B, the verification data associated with the second part (Content B1) provided may comprise Hash(Content A1), Hash(Content B1), Hash C1, Hash C2, Hash C12, Hash C34 and Hash C1234.

In one or more example methods, the method comprises obtaining S102 the content data.

In some examples, obtaining the content data comprises receiving and/or retrieving the content data, e.g. from memory circuitry and/or an external device, such as a server device and/or a database. In one or more example methods, the method comprises receiving S104 a user parameter indicative of the delimiter. For example, the electronic device may be configured to obtain a user parameter (e.g., based on a user input of a user of the electronic device). The user parameter may comprise a delimiter. The delimiter is for example paragraph jump and/or a heading. For example, a delimiter may be a header and/or a footer. In some examples, the delimiter is based on user input (e.g., a user parameter), size, convention, etc. For example, when the content (e.g., the electronic document) is a contract, the method may comprise breaking (e.g., using a heading as a delimiter) the contract into the clauses.

In one or more example methods, the method comprises generating S106, based on a delimiter, a pair including the first part and the second part. In other words, the pair comprises the first part of the content data, and the second part of the content data. For example, generating a pair including the first part and the second part comprises applying a delimiter to the content data. For example, when the content is a contract, the pair may comprise a first clause and a second clause.

In one or more example methods, the authentication tree data comprises the first part and the second part. In the authentication tree, the content data (e.g., the pairs of content data) may be represented by leaf nodes. In some examples, the first part is represented by a first leaf node of the authentication tree. In some examples, the second part is represented by a second leaf node of the authentication tree.

In one or more example methods, the authentication tree is characterized by a one-way function. In one or more example methods, the one-way function is a hash function. For example, the hash function is a Secure Hash Algorithm (SHA). In some examples, the hash function is SHA-1, SHA-2 and/or SHA-3.

In one or more example methods, wherein obtaining S108 the authentication tree comprises generating S108A the authentication tree.

In some examples, generating the authentication tree comprises generating a hash tree. For example, generating the authentication tree comprises generating a Merkle authentication tree.

In one or more example methods, generating S108A the authentication tree comprises determining S108AA a first primary path hash value by applying the one-way function to the first part.

For example, when the content (e.g., electronic document) is a contract, the first primary path hash value may be associated with a first clause of a contract. In some examples, determining (e.g., computing) the first primary path hash value comprises applying the one-way function to the first part of a content (e.g., first clause of a contract).

For example, as shown in FIG. 2A-B, Hash(Content A1) may be based on Content A1. For example, determining Hash(Content A1) (e.g., the first primary path hash value) comprises applying the one-way function to Content A1 (e.g., the first part).

In one or more example methods, generating S108A the authentication tree comprises determining S108AB a first secondary path hash value by applying the one-way function to the second part. In some examples, determining (e.g., computing) the first secondary path hash value comprises applying the one-way function to the second part of a content (e.g., second clause of a contract). In some examples, the first primary path hash value and the first secondary path hash value may be seen as child nodes of the first tertiary path hash value (e.g., parent node). For example, as shown in FIG. 2A-B, Hash(Content B1) may be obtained by applying the one-way function to Content B1 (e.g., the second part). For example, determining Hash(Content B1) (e.g., the first secondary path hash value) comprises applying the one-way function to Content B1 (e.g., the second part).

In one or more example methods, generating S108A the authentication tree comprises determining S108AC a first tertiary path hash value by applying the one-way function to the first primary path hash value and the first secondary path hash value.

In some examples, generating the authentication tree comprises computing a first tertiary path hash value by applying the one-way function to the first primary path hash value and the first secondary path hash value. For example, as shown in FIG. 2A-B, Hash C1 may be based on Hash(Content A1) (e.g., the first primary path hash value) and Hash(Content B1) (e.g., the second primary path hash value). For example, determining Hash C1 (e.g., the first tertiary path hash value) comprises applying the one-way function to Hash(Content A1) and Hash(Content B1). For example, the first tertiary path hash value may be a seen as a parent node of the first primary path hash value and the first secondary path hash value.

The first tertiary path hash value may be seen as a path hash value of the first primary path hash value and the first secondary path hash value. For example, the path hash value may be seen as a parent node of a plurality of (e.g., 2) child nodes. In some examples, determining (e.g., computing) a parent node (e.g., a combined path hash value) is repeated recursively until the parent node (e.g., the combined hash value) is the root of the authentication tree (e.g., Hash C1234 as shown in FIGS. 2A-B).

In some examples, when the content data comprises (e.g., such as only comprises) a first part and a second part, the first tertiary path hash value may be seen as the root hash value.

In one or more example methods, the method comprises storing S110 in a storage medium, the authentication tree. In some examples, the first electronic device (such as the first electronic device 300 of FIG. 5) may be configured to store the authentication tree. For example, the authentication tree may be stored on the memory circuitry of the first electronic device and/or in a server device for later retrieval.

In one or more example methods, obtaining S108 the authentication tree comprises receiving S108B, from a storage medium, the authentication tree.

In some examples, obtaining the authentication tree comprises receiving the authentication tree from a server (e.g., a server storing the authentication tree).

In one or more example methods, the content data comprises a third part and a fourth part. In one or more example methods, the authentication tree data comprises a second primary path hash value associated with the third part, a second secondary path hash value associated with the fourth part, and a second tertiary path hash value associated with a second path of the authentication tree between the root and at least one of the third part and the fourth part. In some examples, determining (e.g., computing) the second primary path hash value comprises applying the one-way function to the third part of a content (e.g., third clause of a contract). For example, as shown in FIG. 2A-B, Hash(Content A2) may be based on Content A2. For example, determining Hash(Content A2) (e.g., the second primary path hash value) comprises applying the one-way function to Content A2 (e.g., the third part). For example, when the content (e.g., electronic document) is a contract, the second secondary path hash value may be associated with a fourth clause of a contract. In some examples, determining (e.g., computing) the second secondary path hash value comprises applying the one-way function to the fourth part of a content (e.g., fourth clause of a contract). In some examples, the second primary path hash value and the second secondary path hash value may be seen as child nodes of the second tertiary path hash value (e.g., parent node). For example, as shown in FIG. 2A-B, Hash(Content B2) may be based on Content B2 (e.g., the fourth part). For example, determining Hash(Content B2) (e.g., the second secondary path hash value) comprises applying the one-way function to Content B2 (e.g., the fourth part). In some examples, the second tertiary path hash value associated with a second path of the authentication tree is generated by applying the one-way function to the second primary path hash value and the second secondary path hash value.

In one or more example methods, the authentication tree comprises a root of the first path and the second path, and wherein the authentication tree data comprises a root hash value associated with the root. The root hash value is for example resulting from path hash values on paths to the entire content parts associated with the leaf nodes of the authentication tree. For example, as shown in FIG. 2A-B, the Hash C1234 (e.g., the root hash value) is based on Content A1-4 and Content B1-4 (e.g., all content parts).

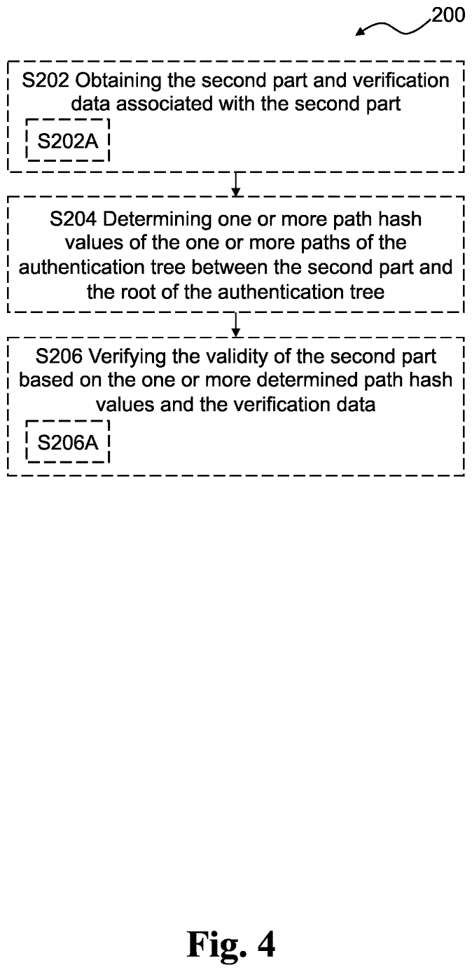

FIG. 4 shows a flow diagram of an example method, performed by a second electronic device, for verifying a validity of a part of a content according to the disclosure. The method 200 is performed by a second electronic device, such as the second electronic device disclosed herein, such as second electronic device 400 of FIG. 6.

The second electronic device may be seen as a verifier device. The second electronic device is for example the receiver of the second part (e.g., content data, e.g., raw content data) and/or verification data (e.g., path hash values). For example, the second electronic device is configured to obtain (e.g., to the second electronic device) the raw content data and the verification data for verification of the raw content data.

The second electronic device may be associated with a recipient. The second electronic device may for example be associated with a third party (e.g., sub-contractor).

Validity of a part of a content may be indicative of whether a part of a content is valid. A valid part of a content does not comprise unauthorized modifications (e.g., tampering). For example, a valid part of a content is a part of content belonging to the given content (e.g., document). For example, a clause of a contract may be considered not valid when not belonging to the corresponding contract.

The method 200 comprises obtaining S202 the second part and verification data associated with the second part. The verification data comprises path hash values of an authentication tree associated with the content data. The authentication tree includes a root and is optionally characterized by a one-way function. The path hash values are for a path between the second part and the root. In some examples, verification data associated with the second part comprises path hash values along the second path. For example, verification data associated with the second part comprises one or more parent nodes and/or one or more sibling nodes associated with the second part. For example, the verification data associated with the second part for example comprises the first primary path hash value and the root hash value.

In the example authentication tree shown in FIGS. 2A-B, the verification data associated with the second part comprises one or more of: the first primary path hash value, the first tertiary path hash value, the second tertiary path hash value, the first quaternary path hash value, the second quaternary path hash value and the root hash value. In other words, for the authentication tree shown in FIGS. 2A-B, the verification data associated with the second part (Content B1 may comprise one or more of: Hash(Content A1), Hash C1, Hash C2, hash C12, Hash C34 and Hash C1234.

In one or more exemplary methods, obtaining S202 verification data comprises receiving S202A and/or retrieving the verification data. For example, obtaining verification data comprises receiving and/or retrieving the verification data from a first electronic device (e.g., first electronic device 300 of FIG. 5).

The method 200 comprises determining S204 one or more path hash values of the one or more paths of the authentication tree between the second part and the root of the authentication tree. In some examples, determining one or more path hash values of the one or more paths of the authentication tree between the second part and the root of the authentication tree comprises determining the one or more path hash values based on the received second part, the authentication tree, and the one-way function. In some examples, determining one or more path hash values of the one or more paths of the authentication tree between the second part and the root of the authentication tree comprises determining the one or more path hash values by applying the one-way function to the received second part, and reiterating the one-way function for each node of the path starting at the second part until the root of the authentication tree. For example, the second electronic device is configured apply the one-way function to the second part received, and to the path hash values determined for each node of the path starting at the second part until the root of the authentication tree.

The method 200 comprises verifying S206 the validity of the second part based on the one or more determined path hash values and the verification data.

In one or more exemplary methods, verifying S206 the validity of the second part based on the one or more determined path hash values and the verification data comprises comparing S206A the one or more determined path hash value and the verification data.

For example, verifying the validity of the second part based on the one or more determined path hash values and the verification data comprises comparing the determined path hash values and the corresponding received path hash values.

In some examples, verifying S206 the validity of the second part comprises comparing a determined first primary path hash value and a received first primary path hash value. For example, comparing the determined path hash value and the received first path hash value comprises comparing a first primary path hash value (e.g., a received path hash value) and a first primary path hash value (e.g., a determined path hash value).

FIG. 5 shows a block diagram of an exemplary first electronic device 300 according to the disclosure. The first electronic device 300 comprises memory circuitry 301, processor circuitry 302, and an interface 303. The first electronic device 300 is configured to perform any of the methods disclosed in FIG. 3. In other words, the electronic device 300 is configured for enabling verification of a second part of a content.

The first electronic device 300 is configured to obtain (e.g., via the memory circuitry 301 and/or the interface 303) an authentication tree comprising a root and authentication tree data associated with the content data, wherein the authentication tree data comprises path hash values associated with a first path of the authentication tree between the second part and the root.

The first electronic device 300 is configured to provide (e.g., via the processor circuitry 302 and/or the interface 303) the second part, and verification data associated with the second part, wherein the verification data comprises the path hash values.

The processor circuitry 302 is optionally configured to perform any of the operations disclosed in FIG. 3 (such as any one or more of: S102, S104, S106, S108, S108A, S108AA, S108AB, S108AC, S108B, S110, S112). The operations of the first electronic device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the first electronic device 300 may be considered a method that the first electronic device 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 5). The memory circuitry 301 is considered a non-transitory computer readable medium.

The memory circuitry 301 may be configured to store content data, a second part of a content, a first part of a content, an authentication tree, authentication tree data, a root, path hash values, verification data, delimiter, a pair, user parameter, a hash function and/or a one-way function in a part of the memory.

FIG. 6 shows a block diagram of an exemplary second electronic device 400 according to the disclosure. The second electronic device 400 comprises memory circuitry 401, processor circuitry 402, and an interface 403. The second electronic device 400 is configured to perform any of the methods disclosed in FIG. 3. In other words, the second electronic device 400 is configured for verifying a validity of a part of a content.

The second electronic device 400 is configured to obtain (e.g., via the memory circuitry 401 and/or the interface 403) the second part and verification data associated with the second part. The verification data comprises path hash values of an authentication tree associated with the content data. The authentication tree includes a root and is characterized by a one-way function. The path hash values are for a path between the second part and the root.

The second electronic device 400 is configured to determine (e.g., via the processor circuitry 402) one or more path hash values of the one or more paths of the authentication tree between the second part and the root of the authentication tree.

The second electronic device 400 is configured to verify (e.g., via the processor circuitry 402) the validity of the second part based on the one or more determined path hash values and the verification data.

The processor circuitry 402 is optionally configured to perform any of the operations disclosed in FIG. 6 (such as any one or more of: S202, S202A, S204, S206, S206A). The operations of the second electronic device 400 may be embodied in the form of executable logic routines (e.g., lines of code, software programs, etc.) that are stored on a non-transitory computer readable medium (e.g., the memory circuitry 401) and are executed by the processor circuitry 402).

Furthermore, the operations of the second electronic device 400 may be considered a method that the second electronic device 400 is configured to carry out. Also, while the described functions and operations may be implemented in software, such functionality may as well be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 6). The memory circuitry 401 is considered a non-transitory computer readable medium.

The memory circuitry 401 may be configured to store content data, first part of a content, second part of a content, verification data, path hash values, authentication tree, a root and/or a one-way function in a part of the memory.

Embodiments of methods and products (first electronic device and second electronic device) according to the disclosure are set out in the following items:

Item 1. A method, performed by a first electronic device, for enabling verification of a second part of a content, wherein the content comprises content data including a first part and the second part, the method comprising:
obtaining an authentication tree comprising a root and authentication tree data associated with the content data, wherein the authentication tree data comprises path hash values associated with a first path of the authentication tree between the second part and the root; and providing the second part, and verification data associated with the second part, wherein the verification data comprises the path hash values.

Item 2. The method according to item 1, the method comprising:
obtaining the content data; and
generating, based on a delimiter, a pair including the first part and the second part.

Item 3. The method according to item 2, the method comprising receiving a user parameter indicative of the delimiter.

Item 4. The method according to any of the previous items, wherein the authentication tree data comprises the first part and the second part.

Item 5. The method according to any of the previous items, wherein the authentication tree is characterized by a one-way function.

Item 6. The method according to any of the previous items, wherein obtaining the authentication tree comprises generating the authentication tree.

Item 7. The method according to items 5 and 6, wherein generating the authentication tree comprises:
determining a first primary path hash value by applying the one-way function to the first part;
determining a first secondary path hash value by applying the one-way function to the second part; and determining a first tertiary path hash value by applying the one-way function to the first primary path hash value and the first secondary path hash value.

Item 8. The method according to item 7, wherein the method comprises storing in a storage medium, the authentication tree.

Item 9. The method according to any of the previous items, wherein obtaining the authentication tree comprises receiving, from a storage medium, the authentication tree.

Item 10. The method according to any of the previous items, wherein the one-way function is a hash function.

Item 11. The method according to any of the previous items, wherein the content data comprises a third part and a fourth part, wherein the authentication tree data comprises a second primary path hash value associated with the third part, a second secondary path hash value associated with the fourth part, and a second tertiary path hash value associated with a second path of the authentication tree between the root and at least one of the third part and the fourth part.

Item 12. The method according to item 11, wherein the authentication tree comprises a root of the first path and the second path, and wherein the authentication tree data comprises a root hash value associated with the root.

Item 13. A method, performed by a second electronic device, for verifying a validity of a part of a content, wherein the content comprises content data including a first part and a second part, the method comprising:
obtaining the second part and verification data associated with the second part, wherein the verification data comprises path hash values of an authentication tree associated with the content data, wherein the authentication tree includes a root and is characterized by a one-way function, wherein the path hash values are for a path between the second part and the root;
determining one or more path hash values of the one or more paths of the authentication tree between the second part and the root of the authentication tree; and
verifying the validity of the second part based on the one or more determined path hash values and the verification data.

Item 14. The method according to item 13, wherein verifying the validity of the second part based on the one or more determined path hash values and the verification data comprises comparing the one or more determined path hash value and the verification data.

Item 15. The method according to any of items 13-14, wherein obtaining verification data comprises receiving and/or retrieving the verification data.

Item 16. The method according to any of the previous items, wherein the content comprises an electronic document.

Item 17. A first electronic device comprising memory circuitry, processor circuitry, and an interface, wherein the first electronic device is configured to perform any of the methods according to any of items 1-12 and 16.

Item 18. A computer readable storage medium storing one or more programs, the one or more programs comprising instructions, which when executed by a first electronic device cause the first electronic device to perform any of the methods of items 1-12 and 16.

Item 19. A second electronic device comprising memory circuitry, processor circuitry, and an interface, wherein the second electronic device is configured to perform any of the methods according to any of items 13-16.

Item 20. A computer readable storage medium storing one or more programs, the one or more programs comprising instructions, which when executed by a second electronic device cause the second electronic device to perform any of the methods of items 13-16.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-6 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a first electronic device, for enabling verification of a second part of a content, wherein the content comprises content data including a first part and the second part, the method comprising:
obtaining an authentication tree comprising a root and authentication tree data associated with the content data, wherein the authentication tree data comprises path hash values associated with a first path of the authentication tree between the second part and the root; and
providing the second part and verification data associated with the second part, wherein the verification data comprises the path hash values.

2. The method according to claim 1, the method comprising:
obtaining the content data; and
generating, based on a delimiter, a pair including the first part and the second part.

3. The method according to claim 2, the method comprising receiving a user parameter indicative of the delimiter.

4. The method according to claim 1, wherein the authentication tree data comprises the first part and the second part.

5. The method according to claim 1, wherein the authentication tree is characterized by a one-way function.

6. The method according to claim 1, wherein obtaining the authentication tree comprises generating the authentication tree.

7. The method according to claim 5, wherein generating the authentication tree comprises:
determining a first primary path hash value by applying the one-way function to the first part;
determining a first secondary path hash value by applying the one-way function to the second part; and
determining a first tertiary path hash value by applying the one-way function to the first primary path hash value and the first secondary path hash value.

8. A method, performed by a second electronic device, for verifying a validity of a part of a content, wherein the content comprises content data including a first part and a second part, the method comprising:
obtaining the second part and verification data associated with the second part, wherein the verification data comprises path hash values of an authentication tree associated with the content data, wherein the authentication tree includes a root and is characterized by a one-way function, wherein the path hash values are for a path between the second part and the root;
determining one or more path hash values of the one or more paths of the authentication tree between the second part and the root of the authentication tree; and
verifying the validity of the second part based on the one or more determined path hash values and the verification data.

9. The method according to claim 8, wherein verifying the validity of the second part based on the one or more determined path hash values and the verification data comprises comparing the one or more determined path hash value and the verification data.

10. The method according to claim 1, wherein the content comprises an electronic document.
